(19) United States
(12) Patent Application Publication
(10) Pub. No.: US 2015/0124285 A1
(43) Pub. Date: May 7, 2015

(54) METHOD AND SYSTEM OF MANAGING DATA OF AN IMAGE FORMING APPARATUS

(71) Applicants: Toshiba Tec Kabushiki Kaisha, Tokyo (JP); Kabushiki Kaisha Toshiba, Tokyo (JP)

(72) Inventor: TAKAO IWASAKI, Tokyo (JP)

(73) Assignees: Toshiba Tec Kabushiki Kaisha, Tokyo (JP); Kabushiki Kaisha Toshiba, Tokyo (JP)

(21) Appl. No.: 14/073,596

(22) Filed: Nov. 6, 2013

(51) Int. Cl. G06F 3/12; H04N 1/00

(52) U.S. Cl. CPC G06F 3/1214; G06F 3/1238; G06F 3/1254; H04N 1/00384; H04N 1/00503; H04N 1/00514
USPC 358/1.15

(57) ABSTRACT

A method for managing data in a system including an image processing apparatus and a server includes storing, in the image processing apparatus, first menu data having one or more parameters set by a user and associated with an operation of the image processing apparatus, and a corresponding first time at which the first menu data was most recently updated, and storing, in the server, second menu data having one or more parameters set by the user and associated with the operation of the image forming apparatus, and a corresponding second time at which the second menu data was most recently updated. The method further includes determining the older and newer of the first time and the second time, and replacing the first or second menu data determined to have the corresponding older time with the other menu data determined to have the corresponding newer time.

### FIELD

Embodiments described herein relate generally to a technique of managing data.

### BACKGROUND

Some multi function peripherals (MFPs) having a plurality of functions such as copying, scanning, printing, and faxing provide for setting of plural parameters (setting of an operation mode) with a single operation on an operation panel by a user. For example, various types of parameter settings such as setting of an image mode or a magnification in copying, setting of a resolution or a transmission destination of an image in scanning, and setting of a destination or polling in faxing can be carried out with a single operation of a menu button. Further, some of the MFPs can associate the menu button with a particular user by combining operation of the menu button with user authentication.

Incidentally, there is a technique in which menu data that is related to one or more setting parameters associated with the menu button, is stored in a server so that multiple MFPs connected to the server can acquire the same menu data. With such a technique, the same parameter setting can be carried out in any MFP connected to the server through a network.

In the above technique, when a user selects a menu button of an MFP, the MFP acquires menu data corresponding to the menu button, that is, the parameters associated with the menu button, from the server through the network. The MFP sets the acquired parameters to the setting parameters of a job and then executes the job. In the above technique, the MFP has to acquire the parameters from the server through the network sometime between when the user selects the menu button and when the MFP starts to execute the job. For this reason, a substantial delay may occur between when the user selects the menu button and when the MFP starts to execute the job, and this may make the user frustrated. In addition, the menu button cannot be used when the MFP cannot acquire the menu data from the server due to a defect of the server or a network failure.

### DESCRIPTION OF THE DRAWINGS

FIG. 1 illustrates a configuration of a print system according to an embodiment.

FIG. 2 is a block diagram showing a schematic configuration of an MFP included in the print system according to the embodiment.

FIG. 3 illustrates an operation panel of the MFP.

FIG. 4 illustrates the operational panel displaying “my menu” call buttons and shared menu call buttons.

FIG. 5 illustrates the operational panel displaying “my menu” buttons.

FIG. 6 conceptually illustrates synchronization control of menu data carried out in the MFP.

FIG. 7 is a flow chart illustrating the synchronization operation of the MFP when a list of menu buttons is displayed.

### DETAILED DESCRIPTION

According to an embodiment, a method for managing data in a system including an image processing apparatus and a server includes storing, in the image processing apparatus, first menu data having one or more parameters set by a user and associated with an operation of the image processing apparatus, and a corresponding first time at which the first menu data was most recently updated, and storing, in the server, second menu data having one or more parameters set by the user and associated with the operation of the image forming apparatus, and a corresponding second time at which the second menu data was most recently updated. The method further includes determining the older and newer of the first time and the second time, and replacing the first or second menu data determined to have the corresponding older time with the other menu data determined to have the corresponding newer time.

Hereinafter, an embodiment will be described with reference to the accompanying drawings.

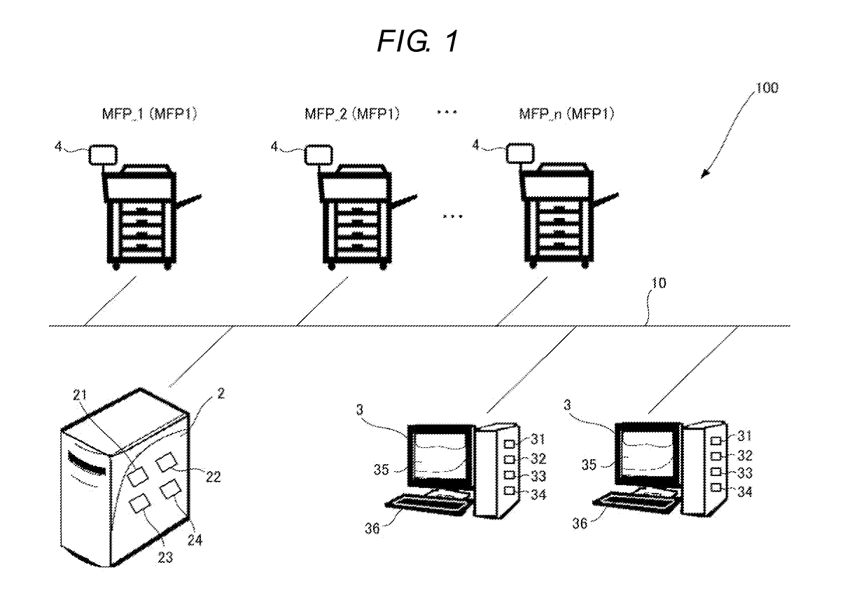

FIG. 1 illustrates a configuration of a print system 100 according to the embodiment. The print system 100 includes a plurality of MFPs 1 (image forming apparatuses), a management server 2, and a plurality of PCs 3 (personal computer). In FIG. 1, the MFPs 1 include MFP_{—}1, MFP_{—}2, . . . , and MFP_n. The MFP_{—}1 to the MFP_n are collectively referred to as the MFPs 1. Hereinafter, when one of the MFPs 1 is individually denoted, the MFP_{—}1, the MFP_{—}2, . . . or the MFP_n may be used as shown in FIG. 1. The MFPs 1, the management server 2, and the PCs 3 are connected to each other through a network 10 such as a local area network (LAN) so as to be capable of communicating with each other.

The management server 2 stores menu data. As described below, the management server 2 synchronizes the menu data stored therein with menu data stored in the MFP 1. The management server 2 includes a processor 21, a memory 22, an HDD (hard disk drive) 23, and a communication interface (I/F) 24. The processor 21 performs various types of functions by executing a program stored in the memory 22 or the HDD 23. The memory 22 may be a read only memory (ROM) or a random access memory (RAM). The communication I/F 24 is an interface that is connected to the PC 3 and the MFP 1. The communication I/F 24 communicates with the PC 3 and the MFP 1 through the network 10 in a wireless or wired manner.

The PC 3 can transmit a job such as a printing job to the MFP 1 through the network 10 so that the MFP 1 performs the job. Similarly to the management server 2, the PC 3 includes a processor 31, a memory 32, an HDD 33, and a communication I/F 34. In addition to these components, the PC 3 includes a display 35 and an operation unit 36. The display 35 displays setting information or the like related to the job. Using the operation unit 36, a user operates the PC3.

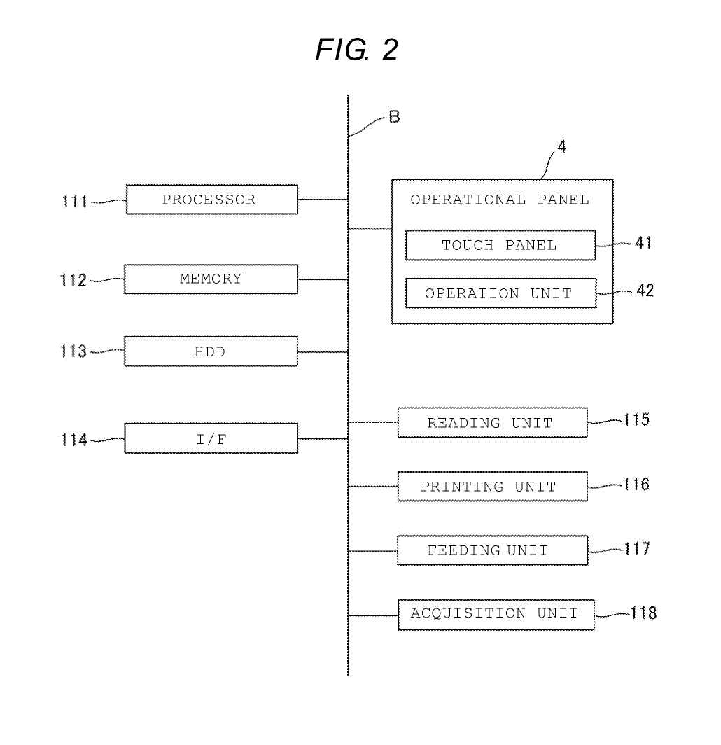

FIG. 2 is a block diagram showing a schematic configuration of the MFP 1.

The MFP 1 performs a plurality of functions such as copying, scanning, printing, or faxing. Similarly to the PC 3 or the management server 2, the MFP 1 includes a processor (controller) 111, a memory 112, an HDD 113, and a communication I/F 114. Further, the MFP 1 includes an operation panel 4, a reading unit 115, a printing unit 116, a paper feeding unit 117, and an acquisition unit 118. The components of the MFP 1 are connected to each other through a bus B. The processor 111 controls the whole MFP 1, including the operation panel 4, by executing a program stored in the memory 112 or the HDD 113.

The reading unit 115 includes a charge coupled device (CCD) and reads out image data corresponding to an image formed on a sheet. For example, the printing unit 116 exposes a photoreceptor on the basis of image data, develop a toner image on the photoreceptor, and transfers the toner image on the photoreceptor to a sheet. The paper feeding unit 117 sends a sheet within a cassette of the MFP 1 to the printing unit 116.

The acquisition unit 118 acquires identification information of a user from an integrated circuit card (IC card) of the user. The processor 111 inquires whether or not the management server 2 authenticates the user. If the management server 2 authenticates the user based on the identification information, the processor 111 allows a log-in of the user. The acquisition unit 118 may acquire a fingerprint or the like of the user as the identification information, or the acquisition unit 118 may acquire a user ID and a password as authentication information input with the operation panel 4. In addition, an authentication table in which authentication information of the user is associated with the identification information of the user may be stored within the memory 112. The processor 111 may perform authentication of the user without inquiring of the management server 2 by referring to the authentication table within the memory 112.

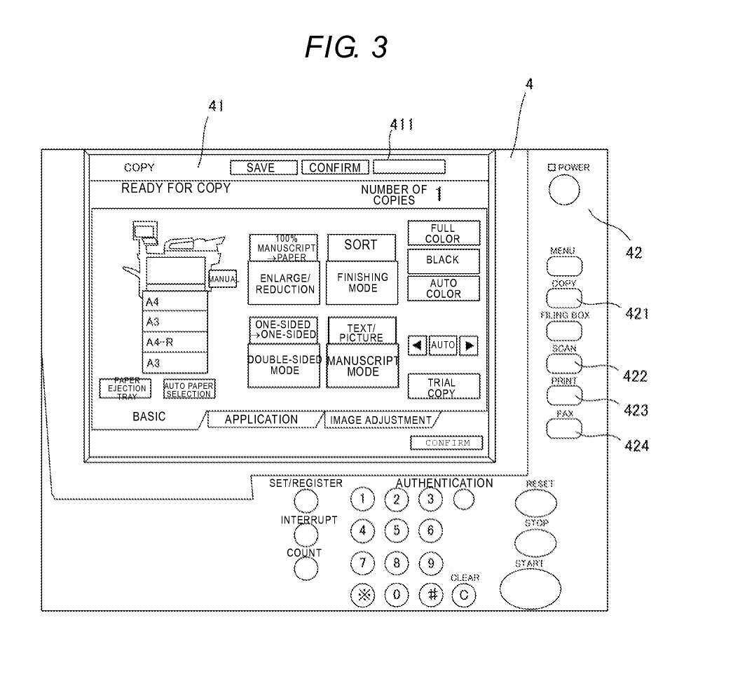

FIG. 3 illustrates the operation panel 4. The operation panel 4 includes a touch panel 41 and an operation unit 42. The touch panel 41 displays setting information and an operation status of the MFP 1, log information, and a notification to a user. The operation unit 42 includes a plurality of operation keys, and with the operation keys the user instructs the MFP 1 to perform functions, such as a start of copying or scanning.

The operation unit 42 includes buttons 421-424 for requesting a user interface (UI) for functions such as copying, scanning, printing, and faxing.

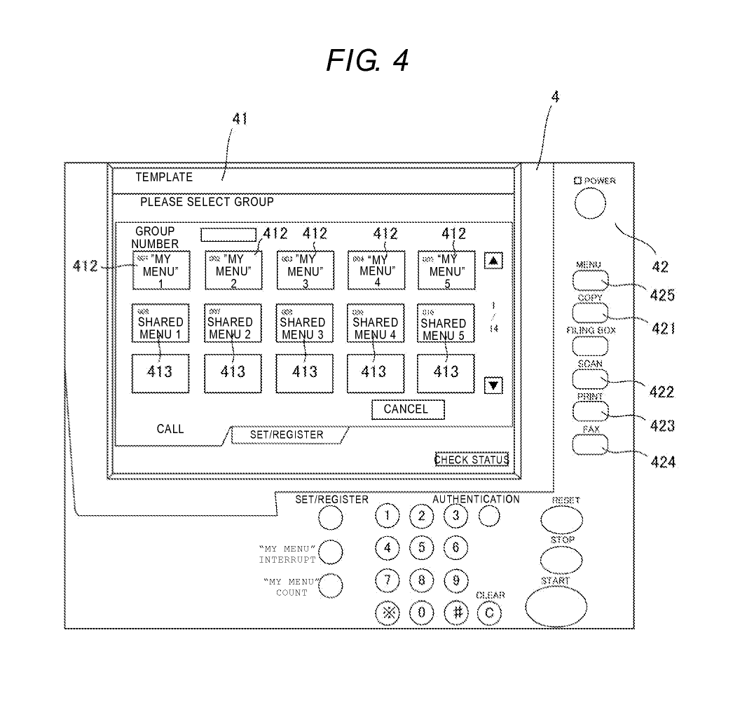

If any of the buttons 421-424 (in FIG. 3, a copy button 421) is pushed, the processor 111 controls the touch panel 41 to display a template button 411. Further, if the template button 411 is selected, the processor 111 controls the touch panel 41 to display “my menu” call buttons 412 and shared menu call buttons 413 as shown in FIG. 4. Meanwhile, if the user is not authenticated, the processor 111 controls the touch panel 41 to display the “my menu” call buttons 412 in a gray color and sets the “my menu” call buttons 412 to be unusable. The processor 111 controls the touch panel 41 to display the shared menu call buttons 413 without changing color irrespective of the user authentication. In addition, if a button 425 provided in the operation unit 42 is pushed, the processor 111 controls the touch panel 41 to display the “my menu” call buttons 412 and the shared menu call buttons 413.

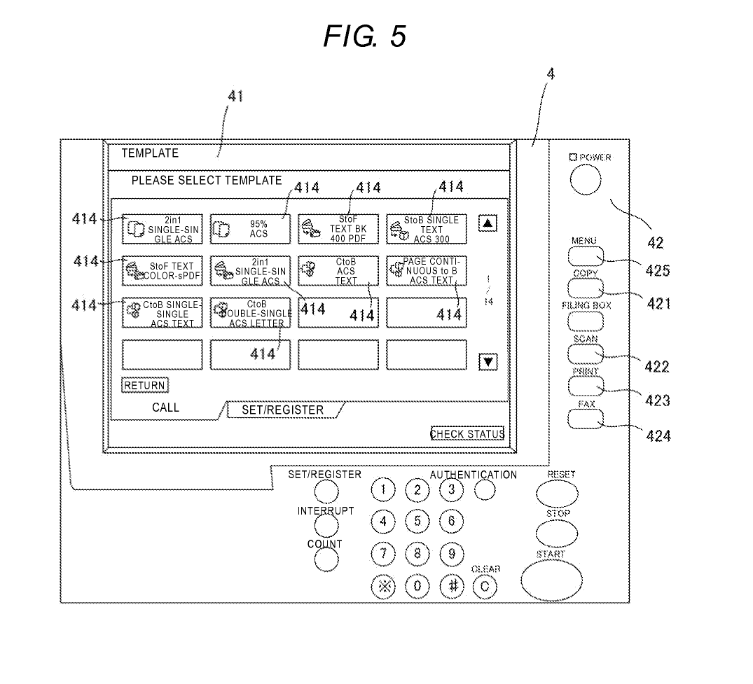

The “my menu” call buttons 412 are buttons for requesting a group (see FIG. 5) of “my menu” buttons set by a user who has logged in to be displayed on the touch panel 41. The shared menu call buttons 413 are buttons for requesting a group of shared menu buttons set by a user who has administrator rights to be displayed on the touch panel 41. If the user has set a plurality of groups (FIG. 5) of the “my menu” buttons, the plurality of the “my menu” call buttons 412, each corresponding to one of the groups, are displayed (“my menu” 1, “my menu” 2, . . . of FIG. 4). In addition, if the user set a plurality of groups of the shared menu buttons, the plurality of the shared menu call buttons 413, each corresponding to one of the groups, are displayed (shared menus 1, 2, . . . of FIG. 4).

When one of the “my menu” call buttons 412 is selected, the processor 111 controls the touch panel 41 to display a group of “my menu” buttons 414 corresponding to the selected “my menu” call button 412 as shown in FIG. 5.

One or more setting parameters related to a function is associated with each of the “my menu” buttons 414. In addition, a letter or a picture indicating the associated setting parameter is displayed in each of the “my menu” buttons 414. For example, 2in1, auto color selection (ACS), and one-sided reading are associated as the setting parameters of a copy function to the “my menu” buttons 414 on the upper left side of FIG. 5. When one of the “my menu” buttons 414 is selected, the processor 111 set the setting parameters associated with the selected “my menu” button 414.

When one of the shared menu call buttons 413 (FIG. 4) is selected, the processor 111 controls the touch panel 41 to display a group of shared menu buttons corresponding to the selected shared menu call button 413. One or more setting parameters of a function is associated with each of the shared menu buttons, and a letter or a picture indicating the associated setting parameter is displayed in each of the shared menu buttons. When one of the shared menu buttons is selected, the processor 111 sets the setting parameters associated with the selected shared menu button.

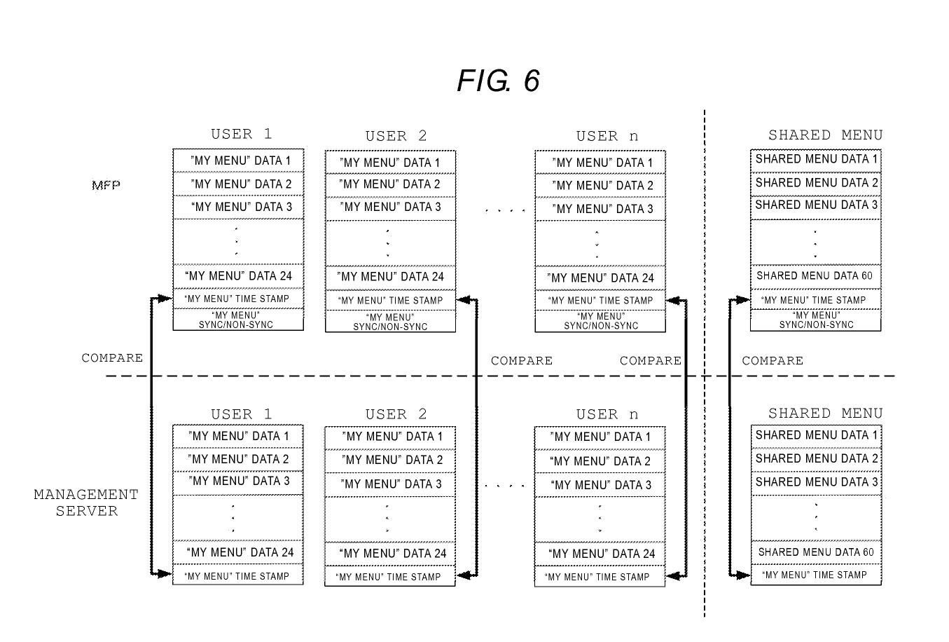

FIG. 6 conceptually illustrates synchronization control of menu data carried out in the MFP 1.

Hereinafter, the setting parameters (a setting parameter group of the plurality of “my menu” buttons 414) associated with the “my menu” buttons 414, each of which is a setting parameter for a certain function, will be referred to as “my menu” data. The MFP 1 stores plural units of “my menu” data (when there are plural units of “my menu” data, the MFP 1 stores these units of “my menu” data) , each of which is associated with one of the users.

A user can edit plural units of “my menu” data as shown in, for example, “my menu” data 1-24 of a user 1 of FIG. 6, and each unit of “my menu” data can correspond to the plurality of “my menu” buttons 414 (parameter setting of each function) which are combined in different manners. Similarly to the “my menu” data, the setting parameters (a setting parameter group of the plurality of shared menu buttons) associated with the shared menu buttons, each of which is a setting parameter for a certain function, will now be referred to as shared menu data.

The memory 22 of the management server 2 stores plural units of the “my menu” data, each of which is associated with one of the users, and plural units of the shared menu data.

When the menu data (“my menu” or the shared menu data) is edited in any of the MFPs 1, the edited menu data (after the termination of the edition) is transmitted to the management server 2 from the MFP 1, and the menu data of the management server 2 is updated. For this reason, in the embodiment, any of the MFP 1 can obtain the latest menu data from the management server 2.

In addition, in the embodiment, since each MFP 1 stores the units of the “my menu” data, each of which is associated with one of the users, and the shared menu data, the menu data can be acquired from the corresponding MFP 1 even in a state where the MFP 1 cannot communicate with the management server 2.

In the embodiment, synchronization control is collectively performed with respect to one “my menu” data group (for example, the “my menu” data 1-24 of the user 1 or “my menu” data 1-24 of a user 2 of FIG. 6) associated with a user. That is, when a “my menu” data of a user is updated in any MFP 1, the “my menu” data group including the updated “my menu” data is transmitted to the management server 2, and the entire units of “my menu” data of the user are collectively updated in the management server 2. With regard to the units of shared menu data, synchronization control is collectively performed for one shared menu data group (shared menu data 1-60 of FIG. 6).

At the time of the updating (at the time of the termination of the edition) of the “my menu” data of the user, the MFP 1 acquires a time stamp indicating an update time of the “my menu” data of the user from the management server 2 and controls the memory 112 to store the time stamp in the memory 112. At this time, the management server 2 also updates the “my menu” data of the user in synchronization with the MFP 1, and controls the memory 22 to store the time stamp indicating the update time of the “my menu” data of the user. In this manner, in the embodiment, the synchronization control of the menu data in the MFP 1 and the menu data in the management server 2 is performed on the basis of one time stamp issued by the management server 2. In addition, in the embodiment, the time stamp indicates the latest timing when any “my menu” data of the “my menu” data group associated with a predetermined user is updated.

When one of the menu call buttons (the “my menu” call button 412 or the shared menu call buttons 413) is selected, the MFP 1 performs the synchronization control of the menu data and then displays a list of the menu buttons. Specifically, the MFP 1 performs different synchronization controls in cases of (A)-(C), as described below.

(A) A case where the time stamp of the MFP 1 is older than the time stamp of the management server 2

The MFP 1 acquires the menu data (“my menu” data or shared menu data of a logged-in user) and the time stamp of the management server 2, and synchronizes the menu data and the time stamp stored in the MFP 1 with the menu data and the time stamp stored in the management server 2 (copies the menu data and the time stamp stored in the management server 2). Then, the MFP 1 displays a list of menu buttons (the “my menu” buttons 414 or the shared menu buttons).

This case corresponds to a case where, for example, the menu data of the management server 2 has been updated in association with an update of the menu data in the MFP_{—}2 (another MFP 1) after the last update of the menu data in, for example, the MFP_1 of FIG. 1.

(B) A case where the time stamp of the MFP 1 is newer than the time stamp of the management server 2

The MFP 1 transmits the menu data and the time stamp to the management server 2, and synchronizes the menu data and the time stamp stored in the management server 2 with the menu data and the time stamp stored in the MFP 1.

This case corresponds to a case where the synchronization with the management server 2 has failed when the MFP 1 updated the menu data.

(C) A case where the time stamp of the MFP 1 is the same as the time stamp of the management server 2

The MFP 1 does not perform synchronization.

This case corresponds to a case where the MFP 1 is the last MFP that has updated the “my menu” data or the shared menu data of the logged-in user.

When the synchronization (copying of the “my menu” data stored in the MFP 1 or in the management server 2) of “my menu” data of a certain user with the management server 2 is completed, the MFP 1 controls the memory 112 to store information indicating that the synchronization of the “my menu” data of the user with the management server 2 is completed, as illustrated in FIG. 6. When the synchronization of the “my menu” data of the user with the management server 2 is not completed due to a network error or a shut-down of the management server 2, the MFP 1 controls the memory 112 to store information indicating that the synchronization of the “my menu” data of the user with the management server 2 is not completed.

In both the case where the synchronization of the shared menu data with the management server 2 is completed and the case where the synchronization of the shared menu data with the management server 2 is not completed, the MFP 1 controls the memory 112 to store information indicating the completion or incompletion of the synchronization.

The MFP 1 regularly performs the synchronization with the management server 2. That is, the MFP 1 regularly transmits the “my menu” data of the user of which synchronization is not yet completed and the shared menu data of which synchronization is not yet completed, to the management server 2 so that the menu data of the management server 2 is updated to the menu data of the MFP 1 of which synchronization is not yet completed.

A synchronization timing of the menu data of each of the MFP 1 and the management server 2 is summarized as cases (4) and (5) in addition to the above-described cases (1)-(3) below.

(1) At the time when the MFP 1 or a PC1 having access to the MFP 1 controls the touch panel 41 to display the menu buttons (the “my menu” buttons 414 or the shared menu buttons) in response to the “my menu” call button 412 or the shared menu call button 413 being selected

The MFP 1 or the PC1 having access to the MFP 1 synchronizes menu data and then controls the touch panel 41 to display a list of the menu buttons.

(2) At the time when edition of the menu data within the MFP 1 is terminated

(3) A regular synchronization

The MFP 1 regularly transmits the synchronization signal of the menu data, of which synchronization is not yet completed, with the management server 2 to the management server 2 so that the menu data of the management server 2 is synchronized with the menu data of the MFP 1.

(4) At the time when the operation of the print system 100 is started

When the operation of the print system 100 is started, the management server 2 does not hold the menu data, and only the MFP 1 holds the menu data. When the MFP 1 controls the touch panel 41 to display the menu buttons for the first time in response to the “my menu” call button 412 or the shared menu call button 413 being selected, the MFP 1 transmits the menu data to the management server 2. At this time, the management server 2 holds the menu data. The MFP 1 controls the touch panel 41 to display a list of the menu buttons after the synchronization of the menu data.

(5) At the time when the MFP 1 is newly added to the network 10

When the MFP 1 is in a state where the MFP 1 can be connected to the management server 2, and then controls the touch panel 41 to display the menu buttons for the first time, the MFP 1 performs the synchronization of the menu data with the management server 2. The MFP 1 controls the touch panel 41 to display a list of the menu buttons after the synchronization of the menu data.

As described above, it is possible to automatically copy the menu data stored in the MFP 1 to the management server 2 when the operation of the print system 100 is started and when the MFP 1 is newly added to the network 10.

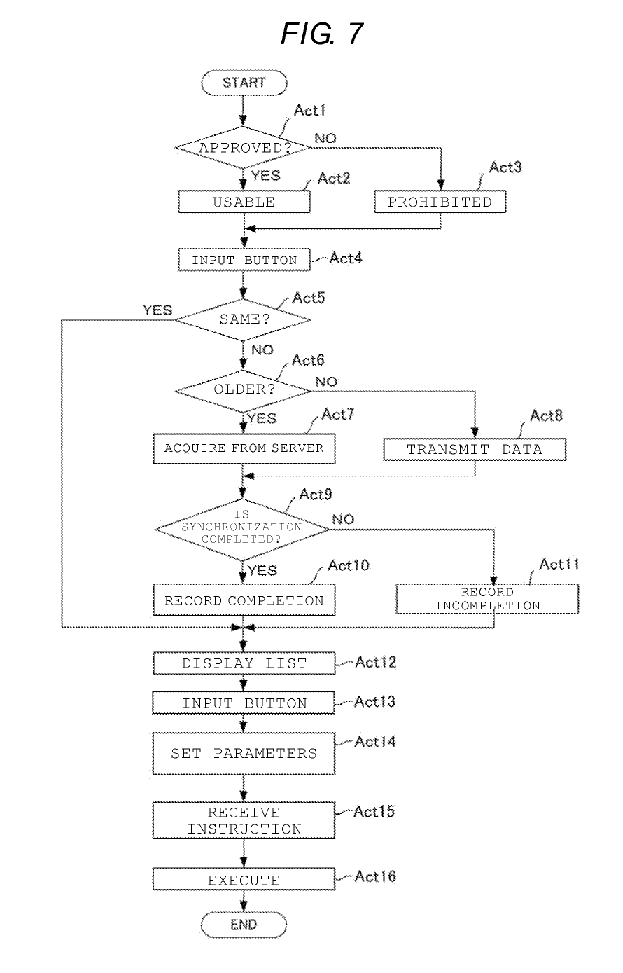

Hereinafter, the synchronization control of the MFP 1 which is described above in (1) when a list of the menu buttons is displayed will be briefly described with reference to a flowchart of FIG. 7.

The acquisition unit 118 of the MFP 1 (the processor 111) acquires identification information of a user, and the MFP 1 inquires of the management server 2 for the authentication of the user (Act1). If the management server 2 approves the user (Act1:YES), the MFP 1 sets the “my menu” call buttons 412 to be in a usable state (Act2). When the management server 2 rejects the user (Act1:NO), the MFP 1 prohibits the use of the “my menu” call buttons 412 (Act3).

The MFP 1 recognizes a selection of the “my menu” call buttons 412 or the shared menu call buttons 413 (Act4).

At this time, the MFP 1 compares the time stamp of the requested menu data (the “my menu” data group or the shared menu data group of the logged-in user) with the time stamp of the menu data stored in the management server 2.

When the time stamp of the MFP 1 is older than the time stamp of the management server 2 (Act5:NO, Act6:YES), the MFP 1 acquires the menu data and the time stamp of the management server 2, and synchronizes the menu data and the time stamp of the MFP 1 with the menu data and the time stamp of the management server 2 (Act7). Meanwhile, such a case corresponds to a case where the menu data of the management server 2 has been updated in association with an update of, for example, the MFP_{—}2 (another MFP 1) of FIG. 1 after the last update of the menu data in the MFP_{—}1 of FIG. 1.

When the time stamp of the MFP 1 is newer than the time stamp of the management server 2 (Act6:NO), the MFP 1 transmits the called menu data (the “my menu” data group or the shared menu data group of the logged-in user) and the time stamp to the management server 2, and synchronizes the menu data and the time stamp of the management server 2 with the menu data and the time stamp of the MFP 1 (Act8). Meanwhile, such a case corresponds to a case where the synchronization with the management server 2 has failed at the time of the update of the menu data in the MFP 1 and the menu data of the management server 2 has not been updated to the edited menu data of the MFP 1 yet.

When the synchronization of the menu data in the MFP 1 with the menu data in the management server 2 is completed (Act9:YES), the MFP 1 stores in the memory 112 information indicating that the synchronization of the menu data is completed (Act10). When the synchronization of the menu data in the MFP 1 with the menu data in the management server 2 is not yet completed (Act9:NO), the MFP 1 stores in the memory 112 information indicating that the synchronization of the menu data is not yet completed (Act11).

When the time stamp of the MFP 1 is the same as the time stamp of the management server 2 (Act5:YES), the MFP 1 does not perform synchronization. Such a case corresponds to a case where the MFP 1 is last MFP that has updated the menu data or the shared menu data of the logged-in user.

After the synchronization control of these, the MFP 1 displays a list of the menu buttons (the “my menu” buttons 414 or the shared menu buttons) on the basis of the synchronized menu data (Act12).

When the MFP 1 recognizes a selection of any menu button by a user (Act13), the MFP 1 sets a parameter that is associated with the selected menu button (Act14).

The MFP 1 recognizes the user's operation of the operation panel 4 instructing execution of a job in accordance with the set parameter (Act15), and executes the job (Act16).

Here, for example, a timing when the MFP 1 acquires the identification information from an IC card may be considered as a timing of the synchronization control of the menu data. In this case, the MFP 1 performs the synchronization control after the MFP 1 inquires for the authentication of the IC card presented. For this reason, the MFP 1 may display a message that “authentication is currently being done” for a long time after the IC card is presented. Since the user usually wants to have a confirmation that the user himself or herself is an authorized user, it is not preferable to perform the synchronization control at this timing.

In addition, the timing when the menu button is selected may be considered as the timing of the synchronization control of the menu data. In this case, the MFP 1 performs the synchronization control after the menu button is selected, and then sets the setting parameter. Thereafter, a job is input to the MFP 1 by the setting parameter that is set by a user, and thus the MFP 1 executes the job. Therefore, when the synchronization control is performed at this timing, a user's instruction for executing the job is delayed by the synchronization control of the MFP 1. However, since the user usually wants to immediately execute the job after selecting the menu button, it is not preferable to perform the synchronization control at this timing.

In the embodiment, the synchronization control is performed at when one of the menu call buttons 412 and 413 etc is selected before a list of the menu buttons is displayed. Since a user usually does not have so strong a desire for fast display during a time from one of the menu call buttons 412 and 413 is selected till the list of the menu buttons is displayed, the synchronization control at this timing. Thus, it is possible to perform the synchronization control while suppressing stress concerning the user.

An order of processes in the embodiment may be different from the order exemplified in the embodiment.

As described above in detail, according to the technique described in the present disclosure, it is possible to provide a technique of managing menu data.

While certain embodiments have been described, these embodiments have been presented by way of example only, and are not intended to limit the scope of the inventions. Indeed, the novel apparatus, methods and system described herein may be embodied in a variety of other forms; furthermore, various omissions, substitutions and changes in the form of the apparatus, methods and system described herein maybe made without departing from the spirit of the inventions. The accompanying claims and their equivalents are intended to cover such forms or modifications as would fall within the scope and spirit of the inventions.

1. A method for managing data in a system including an image processing apparatus and a server, the method comprising:
storing, in the image processing apparatus, first menu data having one or more parameters set by a user and associated with an operation of the image processing apparatus, and a corresponding first time at which the first menu data was most recently updated;
storing, in the server, second menu data having one or more parameters set by the user and associated with the operation of the image forming apparatus, and a corresponding second time at which the second menu data was most recently updated;
determining the older and newer of the first time and the second time; and
replacing the first or second menu data determined to have the corresponding older time with the other menu data determined to have the corresponding newer time.

2. The method according to claim 1, wherein, if the first time is determined to be older than the second time, the first menu data is replaced with the second menu data.

3. The method according to claim 1, wherein, if the second time is determined to be older than the first time, the second menu data is replaced with the first menu data.

4. The method according to claim 3, wherein the second menu data is replaced with the first menu data in response to the first menu data being updated.

5. The method according to claim 1, further comprising:
detecting an input by the user to set the parameters,
wherein the replacing is carried out in response to the detecting of the input.

6. The method according to claim 1, wherein the first time includes a time at which the user sets a certain condition as the one or more parameters.

7. The method according to claim 6, further comprising:
detecting the setting of the certain condition,
wherein the replacing is carried out in response to the detecting of the setting.

8. The method according to claim 1, wherein the first and second menu data are associated with the user.

9. A system comprising:
an image processing apparatus including
a first memory unit configured to store first menu data having one or more parameters set by a user and associated with an operation of the image processing apparatus, and to store a corresponding first time at which the first menu data was most recently updated;
a server including a second memory unit configured to store second menu data corresponding to the first menu data and to store a second time at which the second menu data was most recently updated; and
a controller configured to determine the older and newer of the first time and the second time, and control the first memory unit and the second memory unit to replace the first or second menu data determined to have the corresponding older time with the other menu data determined to have the corresponding newer time.

10. The system according to claim 9, wherein, if the first time is determined to be older than the second time, the controller is configured to control the first memory unit to replace the first menu data with the second menu data.

11. The system according to claim 9, wherein, if the second time is determined to be older than the first time, the controller is configured to causes the second memory unit to replace the second menu data with the first menu data.

12. The system according to claim 11, wherein the controller causes the second menu data to be replaced with the first menu data in response to the first menu data being updated.

13. The system according to claim 9, wherein the controller is configured to detect an input by the user to select the set parameters, and the controller causes the first or second menu data to be replaced in response to the detecting of the input.

14. The system according to claim 9, wherein the first time includes a time at which the user sets a certain condition as the one or more parameters.

15. The system according to claim 14, wherein the controller is configured to detect the setting of the certain condition, and the controller causes the first or second menu data to be replaced in response to the detecting of the setting.

16. The system according to claim 9, wherein the first and second menu data are associated with the user.

17. An image processing apparatus comprising:
a memory unit configured to store first menu data having one or more parameters set by a user and associated with an operation of the image processing apparatus set, and a first time at which the first menu data was most recently updated; and
a controller configured to compare the first time with a second time at which a second menu data, which corresponds to the first menu data and is stored in a server, is most recently updated, and cause the first or second menu data having the older time to be replaced with the other menu data having the newer time.

18. The image processing apparatus according to claim 17, wherein, if the first time is older than the second time, the controller is configured to control the memory unit to replace the first menu data with the second menu data.

19. The image processing apparatus according to claim 17, wherein, if the second time is older than the first time, the controller causes the first menu data and the first time to be transmitted to the server.

20. The system according to claim 19, wherein the controller causes the first menu data and the first time to be transmitted to the server in response to the first menu data being updated.
